(19) United States
(12) Patent Application Publication
(10) Pub. No.: US 2015/0316509 A1
(43) Pub. Date: Nov. 5, 2015

(54) METHOD FOR MEASURING THICKNESS OF BOILER WATER TUBE

(71) Applicant: MITSUBISHI MATERIALS CORPORATION, Tokyo (JP)

(72) Inventors: Nobuhiro OGUMA, Kagawa-gun (JP); Shimpei HIROSE, Kagawa-gun (JP); Kazuya SYOJI, Kagawa-gun (JP); Masatoshi NAKAMURA, Ichihara-shi (JP); Yasuo YASUDA, Tokyo (JP)

(73) Assignee: MITSUBISHI MATERIALS CORPORATION, Tokyo (JP)

(21) Appl. No.: 14/650,133

(22) PCT Filed: Feb. 6, 2014
(86) PCT No.: PCT/JP2014/052746

§ 371 Date: Jun. 5, 2015

(30) Foreign Application Priority Data
Jul. 2, 2013 (JP) 2013-138994

(51) Int. Cl. G01N 29/04

(52) U.S. Cl. CPC G01N 29/043; G01N 2291/044

(57) ABSTRACT

An inspection hole is formed on a side surface of a boiler water tube in a longitudinal direction, a base side of a guide pipe is connected to the inspection hole, and usually, a closing member is attached to the guide pipe. In a case where the thickness of the boiler water tube is measured, the closing member is released from the guide pipe, an ultrasonic probe is inserted into the boiler water tube from a tip side of the guide pipe, and the ultrasonic probe is moved in the boiler water tube.

### TECHNICAL FIELD

The invention relates to a method for measuring a thickness of a boiler water tube by using insertion-type ultrasonic wave thickness measurement, which is performed, for example, as part of an examination of age deterioration of a boiler water tube.

Priority is claimed to Japanese Patent Application No. 2013-138994, filed on Jul. 2, 2013, the content of which is incorporated herein by reference.

### BACKGROUND ART

In the related art, as part of an examination of age deterioration of a boiler water tube having a small diameter, insertion-type ultrasonic wave thickness measurement of the boiler water tube has been performed by using, for example, ultrasonic flaw detecting equipment disclosed in PTL 1. Here, the insertion-type ultrasonic wave thickness measurement of the boiler water tube is performed in the following sequence. First, an inspection hole is provided by cutting a part of the boiler water tube and an ultrasonic flaw detecting probe is inserted in the boiler water tube through the inspection hole. Next, the ultrasonic flaw detecting probe is moved in the boiler water tube while irradiating the inner circumferential surface of the boiler water tube with an ultrasonic wave from the ultrasonic flaw detecting probe at a right angle along a circumferential direction. Accordingly, a thickness distribution along the circumferential direction of the boiler water tube is obtained along a shaft center direction of the boiler water tube.

### CITATION LIST

### Patent Literature

[PTL 1] Japanese Patent No. 3352653

### SUMMARY OF INVENTION

### Technical Problem

However, when the inspection hole is formed by cutting the boiler water tube, the boiler water tube is necessarily restored after the thickness measurement. Therefore, when performing the thickness measurement of the boiler water tube, it is necessary to secure a period of time required for incidental work such as cutting the boiler water tube and restoring the boiler water tube. As a result, a problem that the working rate of the boiler is decreased because a work period required for the thickness measurement of the boiler water tube becomes long arises.

An object of the invention is to provide a method for measuring the thickness of a boiler water tube by the insertion-type ultrasonic wave thickness measurement capable of improving the working rate of the boiler by reducing incidental work accompanying the thickness measurement of the boiler water tube resulting in a considerable shortening of the work period required for the measurement.

### Problem to be Solved by the Invention

According to an aspect of the invention, there is provided a method for measuring the thickness of a boiler water tube which measures the thickness of a boiler water tube by irradiating an inner circumferential surface of the boiler water tube with an ultrasonic wave from an ultrasonic probe while moving the ultrasonic probe inserted in the boiler water tube, the method including: forming an inspection hole on a side surface of the boiler water tube in a longitudinal direction, connecting a base side of a guide pipe to the inspection hole, and usually, attaching a closing member to the guide pipe; and releasing the closing member from the guide pipe, inserting the ultrasonic probe in the boiler water tube from a tip side of the guide pipe, and moving the ultrasonic probe in the boiler water tube when the thickness of the boiler water tube is measured.

According to the aspect of the invention, in the method for measuring the thickness of a boiler water tube, it is preferable that the boiler water tube is in a vertical state, the base side of the guide pipe is connected by being inclined upward in an angular range of 5 degrees to 60 degrees with respect to a shaft center of the boiler water tube, the closing member is a long bolt member, and an air pocket is not formed (that is, an air pocket is prevented from being generated) in a tip side of the bolt member when the bolt member is screwed into the guide pipe. Accordingly, the ultrasonic probe can be inserted in the boiler water tube from the upper side.

According to the aspect of the invention, in the method for measuring the thickness of a boiler water tube, it is preferable that the boiler water tube is in a vertical state, the base side of the guide pipe is connected by being inclined downward in an angular range of 5 degrees to 60 degrees with respect to a shaft center of the boiler water tube, and the closing member is a long bolt member. Accordingly, the ultrasonic probe can be inserted into the boiler water tube from the lower side.

According to the aspect of the invention, in the method for measuring the thickness of a boiler water tube, it is preferable that the boiler water tube is in a horizontal state or an inclined state, the base side of the guide pipe is connected by being inclined in an angular range of 5 degrees to 60 degrees with respect to a shaft center of the boiler water tube, the closing member is a long bolt member, and an air pocket is not formed (that is, an air pocket is prevented from being generated) in a tip side of the bolt member when the bolt member is screwed into the guide pipe. Accordingly, the ultrasonic probe can be inserted in the boiler water tube.

According to the aspect of the invention, in the method for measuring the thickness of a boiler water tube, it is preferable that a plurality of the boiler water tubes are provided, and the guide pipe is provided to all or some of the boiler water tubes as a managing target.

According to the aspect of the invention, in the method for measuring the thickness of a boiler water tube, it is preferable that the guide pipe has a linear shape.

According to the aspect of the invention, in the method for measuring the thickness of a boiler water tube, it is preferable that an examination of age deterioration of the boiler water tube is performed by comparing the measured thickness of the boiler water tube with reference data.

According to the aspect of the invention, in the method for measuring the thickness of a boiler water tube, it is preferable that, when the bolt member is screwed into the guide pipe, a length of the bolt member is set so that a part of a tip of the bolt member is in contact with an edge of the inspection hole on an inner circumferential surface side of the boiler water tube.

According to the aspect of the invention, in the method for measuring the thickness of a boiler water tube, it is preferable that the ultrasonic probe is moved up to a target position, in advance, in the boiler water tube, and then the thickness of the boiler water tube is measured while the ultrasonic probe is pulled back to the inspection hole from the target position.

### Effects of the Invention

According to the aspect of the method for measuring the thickness of a boiler water tube, a guide pipe is provided to a boiler water tube, and usually, the guide pipe is blocked by attaching a closing member to the guide pipe, thereby operating the boiler. In addition, when the thickness of the boiler water tube is measured, the closing member is released from the guide pipe, and the ultrasonic probe can be inserted into the boiler water tube through the guide pipe. Therefore, incidental work such as cutting the boiler water tube and restoring the boiler water tube after the thickness measurement, which is necessary for inserting the ultrasonic probe into the boiler water tube in the related art, can be reduced, and thus a work period required for insertion-type ultrasonic wave thickness measurement of the boiler water tube can be considerably shortened. Further, since the work period required for the thickness measurement of the boiler water tube and the boiler restoration can be shortened, it is possible to easily cope with the emergency inspection of the boiler water tube.

In the aspect of the method for measuring the thickness of a boiler water tube, in a case where the boiler water tube is in a vertical state and the base side of the guide pipe is connected by being inclined upward in an angular range of 5 degrees to 60 degrees with respect to a shaft center of the boiler water tube, the ultrasonic probe can be easily inserted into the boiler water tube from the upper side of the boiler water tube through the guide pipe, and the ultrasonic probe can be easily taken out to the outside from the boiler water tube through the guide pipe. In addition, in a case where the closing member is a long bolt member and an air pocket is not formed in a tip side of the bolt member when the bolt member is screwed into the guide pipe, the operation efficiency of the boiler can be stable.

In the aspect of the method for measuring the thickness of a boiler water tube, in a case where the boiler water tube is in a vertical state, the base side of the guide pipe is connected by being inclined downward in an angular range of 5 degrees to 60 degrees with respect to a shaft center of the boiler water tube, and the closing member is a long bolt member, the ultrasonic probe can be easily inserted into the boiler water tube from the lower side of the boiler water tube through the guide pipe, and the ultrasonic probe can be easily taken out to the outside from the boiler water tube through the guide pipe.

In the aspect of the method for measuring the thickness of a boiler water tube, in a case where the boiler water tube is in a horizontal state or an inclined state and the base side of the guide pipe is connected by being inclined in an angular range of 5 degrees to 60 degrees with respect to a shaft center of the boiler water tube, the ultrasonic probe can be easily inserted into the boiler water tube through guide pipe, and the ultrasonic probe can be easily taken out to the outside from the boiler water tube through the guide pipe. In addition, in a case where the closing member is a long bolt member, the bolt member is screwed into the guide pipe, and an air pocket is not formed in a tip side of the bolt member, the operation efficiency of the boiler can be stable.

In the aspect of the method for measuring the thickness of a boiler water tube, in a case where a plurality of the boiler water tubes are provided, and the guide pipe is provided to all of the boiler water tubes, an examination of age deterioration of the boiler water tube can be performed by measuring the thickness of each of the boiler water tubes. In addition, in a case where the guide pipe is provided to some of the boiler water tubes as a managing target, the examination of age deterioration of the boiler water tube can be efficiently performed at low cost. Accordingly, it is possible to determine the effective period for regular inspection of the boiler and to perform efficient maintenance of the boiler water tube.

In the aspect of the method for measuring the thickness of a boiler water tube, in a case where the guide pipe has a linear shape, the attachment of the guide pipe to the boiler water tube can be easily performed, and inserting and taking out the ultrasonic probe into and from the boiler water tube can be easily performed.

In the aspect of the method for measuring the thickness of a boiler water tube, in a case where the examination of age deterioration of the boiler water tube is performed by comparing the measured thickness of the boiler water tube with reference data, since the thickness of the boiler water tube can be measured by performing the regular inspection of the boiler without the generation of incidental work, the examination of age deterioration can be easily and efficiently performed.

### BRIEF DESCRIPTION OF DRAWINGS

FIG. 1 is a diagram showing a boiler water tube to which a method for measuring the thickness of a boiler water tube according to an embodiment of the invention is applied.

FIG. 2 is a diagram showing the method for measuring the thickness of the boiler water tube.

### DESCRIPTION OF EMBODIMENTS

For the understanding of the invention, a concrete embodiment of the invention will be described with reference to the accompanying drawings.

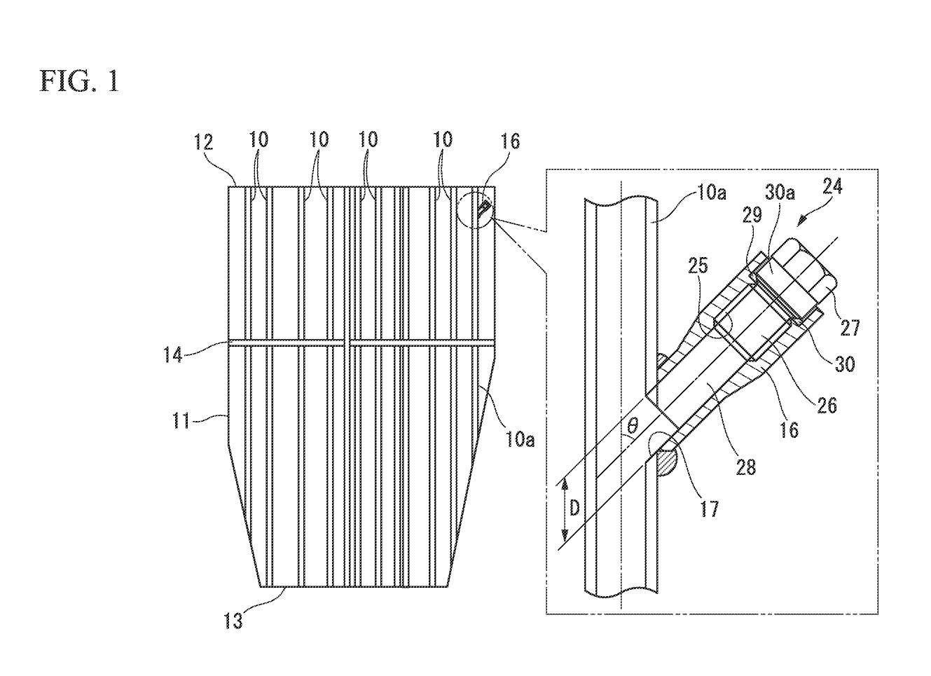

First, description will be given of a boiler water tube 10a in a vertical state and another boiler water tube 10 in a vertical state (refer to FIG. 1), to which a method for measuring the thickness of a boiler water tube according to an embodiment of the invention is applied.

A plurality of boiler water tubes 10 and 10a are arranged in a boiler water tubes panel 11 along a vertical direction with gaps therebetween set in advance, and water passes through the inside of the boiler water tubes 10 and 10a.

An upper end of each of the boiler water tubes 10 and 10a is suspended on a beam of a building. Therefore, the arrangement of the boiler water tubes 10 and 10a in the boiler water tubes panel 11 is fixed.

Further, a header 14 communicates with an intermediate portion of each of the boiler water tubes 10 and 10a in a longitudinal direction. A linear guide pipe 16 is attached to an end in the longitudinal direction of some boiler water tubes 10a (for example, arranged at a specific position in the boiler water tubes panel 11) set as a managing target in the boiler water tubes 10 and 10a, for example, and to a side surface on the downstream side of an upper end plate 12. The position of the guide pipe 16 is not limited to the end in the longitudinal direction of the boiler water tubes 10 and 10a, and the guide pipe 16 can be attached to any position of the side surface in the longitudinal direction. Hereinafter, the details thereof will be described.

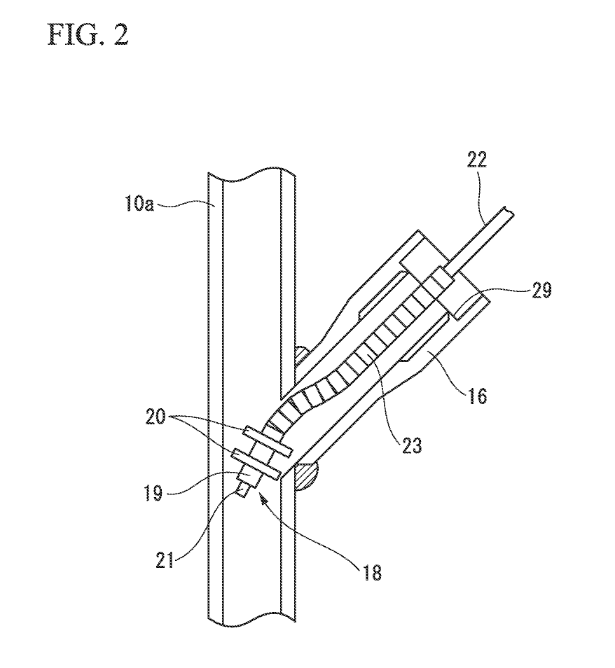

The base side of the guide pipe 16 is fixed, by welding, to an inspection hole 17 that has a long-hole shape and is formed on the side surface of the boiler water tube 10a, by being inclined upward in a range of 5 degrees to 60 degrees with respect to a shaft center of the boiler water tube 10a. Here, as shown in FIG. 2, a disc-shaped aligning member 20 is attached to an outer circumferential side of an ultrasonic probe 18 that is inserted into the boiler water tube 10a through the guide pipe 16 when measuring the thickness of the boiler water tube 10a. When the ultrasonic probe 18 is inserted into the boiler water tube 10a, the outer circumferential surface of the aligning member 20 comes in contact with the inner circumferential surface of the boiler water tube 10a, and thereby, the central position of the ultrasonic probe 18 is maintained at the central position of the boiler water tube 10a. Therefore, the inner diameter of the guide pipe 16 is set to have the same dimension as, for example, the inner diameter of the boiler water tube 10a due to the constraints that the aligning member 20 can pass through the guide pipe 16 and the guide pipe 16 can be easily connected to the boiler water tube 10a through the inspection hole 17 formed on the boiler water tube 10a.

Since the inclination angle θ of the guide pipe 16 with respect to the boiler water tube 10a is 5 degrees or more and 60 degrees or less, as shown in FIG. 2, the ultrasonic probe 18 can be easily inserted in the boiler water tube 10a through the guide pipe 16. Further, in a case where inclination angle θ of the guide pipe 16 with respect to the boiler water tube 10a is less than 5 degrees, the dimension of a major axis D of the inspection hole 17 formed on the side surface of the boiler water tube 10a is increased, which is not preferable. Meanwhile, in a case where inclination angle θ of the guide pipe 16 with respect to the boiler water tube 10a is more than 60 degrees, it is necessary to greatly change the traveling direction of the ultrasonic probe 18 when the ultrasonic probe 18 is inserted into the boiler water tube 10a from the guide pipe 16, and it is difficult to manipulate the movement of the ultrasonic probe 18 because a plurality of (two in FIG. 2) disc-shaped aligning members 20 (which causes the shaft center position of the probe accommodating unit 19 to match the shaft center position of the boiler water tube 10a) are attached to the outer circumferential side of a probe accommodating unit 19 of the ultrasonic probe 18, which is not preferable. Further, in some circumstances, there is a problem in that the ultrasonic probe 18 cannot be inserted into the boiler water tube 10a.

Here, reference sign 21 indicates an acoustic mirror unit, and the acoustic mirror unit is rotatably attached to a tip end of the probe accommodating unit 19 so that the rotation central axis thereof matches the shaft center position of the probe accommodating unit 19. The acoustic mirror unit 21 rotates due to water flow passing through the probe accommodating unit 19, and has a function of changing the traveling direction of the ultrasonic wave radiated from a probe accommodated in the probe accommodating unit 19 along the central axis direction of the boiler water tube 10a, to the radially outward direction of the boiler water tube 10a. Reference sign 22 indicates a cable having flexibility, and the cable accommodates a signal cable of the probe and supplies water in the probe accommodating unit 19. Reference sign 23 indicates a flexible metal hose, and the flexible metal hose connects the probe accommodating unit 19 to the cable 22. In this configuration, if the ultrasonic wave is radiated from the probe while the acoustic mirror unit 21 is rotated, the inner circumferential surface of the boiler water tube 10a can be irradiated with the ultrasonic wave at a right angle along the circumferential direction. Further, a portion of the ultrasonic wave which is reflected by the inner circumferential surface of the boiler water tube 10a, is reflected again by the acoustic mirror unit 21, and is incident on the probe. In addition, the remainder of the ultrasonic wave enters the inside of the boiler water tube 10a, is reflected by the outer circumferential surface of the boiler water tube 10a, passes through the inside of the boiler water tube 10a, is reflected again by the acoustic mirror unit 21, and is incident on the probe.

Accordingly, an inner-circumferential-surface measurement time until the ultrasonic wave radiated from the probe is reflected by the inner circumferential surface of the boiler water tube 10a and is incident on the probe, and an outer-circumferential-surface measurement time until the ultrasonic wave radiated from the probe is reflected by the outer circumferential surface of the boiler water tube 10a and is incident on the probe are measured, and a measurement time difference is obtained. Therefore, it is possible to obtain the thickness of the boiler water tube 10a. Here, in the boiler water tube 10a in a sound state, an inner-circumferential-surface sound time until the ultrasonic wave radiated from the probe is reflected by the inner circumferential surface of the boiler water tube 10a and is incident on the probe, and an outer-circumferential-surface sound time until the ultrasonic wave radiated from the probe is reflected by the outer circumferential surface of the boiler water tube 10a and is incident on the probe are measured, and a sound time difference is obtained. Therefore, it is possible for the decrement of the thickness of the boiler water tube 10a to be calculated based on the difference between the sound time difference and the measurement time difference. In the invention, the sound state of the boiler water tube 10a means a state in which the thickness of the boiler water tube 10a is not decreased (is not corroded). Further, in a case where the inner-circumferential-surface measurement time is longer than the inner-circumferential-surface sound time, it can be determined that the thickness on the inner circumferential surface side of the boiler water tube 10a is decreased (corroded), and in a case where the outer-circumferential-surface sound time is shorter than the outer-circumferential-surface sound time, it can be determined that the thickness on outer circumferential surface side of the boiler water tube 10a is decreased (corroded).

As shown in FIG. 1, usually, a long bolt member 24 (an example of closing member) is screwed into the guide pipe 16 from the tip side thereof, and thus the opening of the guide pipe 16 is blocked. Here, the bolt member 24 includes a bolt body portion 26 on which a male screw that is screwed into a female screw unit 25 is formed on the inner surface on the tip side of the guide pipe 16; a bolt head portion 27 that is provided to be connected to the base side of the bolt body portion 26; and a cylindrical closing portion 28 that is provided to be connected to the tip side of the bolt body portion 26 and is fitted into a region on the base side closer than the female screw unit 25 in the guide pipe 16. Therefore, at the time of operating the boiler, the amount of bubbles present in water in the boiler water tube 10a reaches a level that does not cause a problem in the management of the boiler.

Further, a stepped portion 29 that is opened to the outside is formed on the inner periphery of the tip of the guide pipe 16. By inserting the bolt member 24 in the guide pipe 16 and screwing the bolt body portion 26 together with the female screw unit 25 of the guide pipe 16, the bolt member 24 can be gradually moved in the guide pipe 16 toward the boiler water tube 10a, and the movement of the bolt member 24 can be stopped when the lower surface of the bolt head portion 27 comes in contact with the bottom surface of the stepped portion 29 via a ring-shaped sealing member 30 and a ring-shaped washer 30a. Accordingly, in a case where the lower surface of the bolt head portion 27 is in contact with the bottom surface of the stepped portion 29 via a ring-shaped sealing member 30 and a ring-shaped washer 30a, if the length of the closing portion 28 is set in advance so that a part of the tip of the closing portion 28 is in contact with the inner edge of the inspection hole 17 (edge on the inner circumferential surface of the boiler water tube 10a), when the closing portion 28 is fitted into the guide pipe 16, the highest position of a space portion formed on the base side of the guide pipe 16 can be approximately aligned with the highest position of the inner circumferential surface of the inspection hole 17. Accordingly, at the time of operating the boiler, bubbles present in water in the boiler water tube 10a are prevented from being collected in the space portion formed on the base side of the guide pipe 16, and thus it is possible to prevent an air pocket from being generated at the time of operating the boiler.

Sequentially, the method for measuring the thickness of the boiler water tube according to the embodiment of the invention will be described.

As shown in FIG. 1, among the boiler water tubes 10 and 10a that are long and in a vertical state, a target of the examination for the age deterioration of the thickness of the boiler water tube, that is, the boiler water tube 10a as a managing target is selected in advance. Next, the inspection hole 17 is formed on the side surface of an end of the boiler water tube 10a in the longitudinal direction, in FIG. 1, the side surface of the boiler water tube 10a on the downstream side of the upper end plate 12, and the base side of the guide pipe 16 is connected to the inspection hole 17 by being inclined upward in a range of 5 degrees to 60 degrees with respect to a shaft center of the boiler water tube 10a. In addition, usually, that is, at the time of operating the boiler, the bolt member 24 is screwed into the guide pipe 16 from the tip side thereof and the opening of the guide pipe 16 is blocked. Further, in a case where the guide pipe 16 is blocked by the bolt member 24, the ring-shaped sealing member 30 is disposed on the bottom surface of the stepped portion 29 and then the screwing together is performed.

When the measurement of the thickness of the boiler water tube 10a is performed during the regular inspection of the boiler, the bolt member 24 that blocks the opening of the guide pipe 16 is released from the guide pipe 16 attached to the boiler water tube 10a. Then, water is poured in the boiler water tube 10a and, as shown in FIG. 2, the ultrasonic probe 18 is inserted into the guide pipe 16 from the tip side of the guide pipe 16. Then, the cable 22 is gradually fed into the guide pipe 16, and therefore, the ultrasonic probe 18 is caused to advance, thereby entering the boiler water tube 10a by passing through the guide pipe 16.

When the ultrasonic probe 18 is inserted into the boiler water tube 10a, the outer circumferential surface of the aligning member 20 of the ultrasonic probe 18 comes in contact with the inner circumferential surface of the boiler water tube 10a, and thereby, the shaft center of the probe accommodating unit 19 is positioned at the shaft center position of the boiler water tube 10a. Accordingly, the cable 22 is fed further into the guide pipe 16, and therefore, it is possible to move the ultrasonic probe 18 along the central axis of the boiler water tube 10a. Then, while the acoustic mirror unit 21 is rotated by supplying water into the ultrasonic probe 18 via the cable 22, ultrasonic wave is radiated from the probe, and the cable 22 is fed into the guide pipe 16 at a certain speed. Here, the boiler water tube 10a is filled with water, and thus when the thickness of the boiler water tube 10a is measured, water is discharged from the tip portion of the guide pipe 16.

The ultrasonic probe 18 is moved in the boiler water tube 10a toward a target position on the side of a lower end plate 13 while irradiating the inner circumferential surface of the boiler water tube 10a with an ultrasonic wave at a right angle along the circumferential direction. Accordingly, the trajectory of irradiated points of an ultrasonic wave radiated from the probe of the ultrasonic probe 18, on the inner circumferential surface of the boiler water tube 10a is a spiral along the central axis of the boiler water tube 10a. Therefore, the inner-circumferential-surface measurement time and the outer-circumferential-surface measurement time are respectively obtained for the irradiated points positioned on the spiral. Then, the measurement time difference between the outer-circumferential-surface measurement time and the inner-circumferential-surface measurement time is compared with the sound time difference, and it is determined whether or not the thickness of the boiler water tube 10a is decreased for respective irradiated points. In addition, when the thickness is decreased, based on the magnitude relationship of the inner-circumferential-surface measurement time and the inner-circumferential-surface sound time and the magnitude relationship of the outer-circumferential-surface measurement time and the outer-circumferential-surface sound time, it is determined whether the thickness is decreased on the inner circumferential surface side or the outer circumferential surface side, or on both of the inner and outer circumferential surface sides. Accordingly, it is determined whether the thickness is decreased at each irradiated point, and it is possible to obtain the status of the thickness decrease in the boiler water tube 10a. Further, by comparing reference data (that is, the inner-circumferential-surface sound time, the outer-circumferential-surface sound time, and the sound time difference) with the inner-circumferential-surface measurement time, the outer-circumferential-surface measurement time, and the measurement time difference, the examination of the age deterioration of the boiler water tube 10a can be performed.

If the ultrasonic probe 18 is moved up to the target position in the boiler water tube 10a and the insertion-type ultrasonic wave thickness measurement of the boiler water tube 10a is finished, the irradiation of an ultrasonic wave and the rotation of the acoustic mirror unit 21 are stopped. Next, the cable 22 is gradually pulled out from the guide pipe 16, and the ultrasonic probe 18 is pulled back to the inspection hole 17. Then, the ultrasonic probe 18 is guided in the guide pipe 16, and is taken out to the outside from the tip side of the guide pipe 16. Then, the opening of the guide pipe 16 is blocked by the bolt member 24.

The thickness of the boiler water tube 10a is measured while the ultrasonic probe 18 is moved up to the target position in the boiler water tube 10a; however, the ultrasonic probe 18 is first moved up to the target position, and then the thickness of the boiler water tube 10a can be measured while the ultrasonic probe 18 is pulled back to the inspection hole 17.

As described above, the guide pipe 16 is attached to the boiler water tube 10a, and usually, the opening of the guide pipe 16 is blocked by attaching the bolt member 24 to the guide pipe 16. Further, when the thickness of the boiler water tube 10a is measured, the bolt member 24 is released from the guide pipe 16, and the ultrasonic probe 18 is inserted into the boiler water tube 10a through the guide pipe 16. Accordingly, incidental work such as cutting the boiler water tube and restoring the boiler water tube after the thickness measurement, which is necessary for inserting the ultrasonic probe 18 into the boiler water tube 10a in the related art, can be reduced, and thus the work period required for the regular inspection can be considerably shortened.

As above, the invention has been described with reference to the embodiment, but the invention is not limited to the configuration described in the above embodiment, and includes other embodiments or modification examples that can be considered to be in the range of matters described in the claims.

Further, components obtained by combining the components of the embodiment and the other embodiments or the modification examples are also included in the invention.

For example, the guide pipe is attached to the boiler water tube as a managing target, but the guide pipe can be attached to all of the boiler water tubes.

In addition, in the embodiment, the shape of the guide pipe is a linear shape, but only the base part connected to the inspection hole is made to be bent in the range of 5 degrees to 60 degrees with respect to the boiler water tube and the other part can be made to be linear.

In addition, the base side of the guide pipe is connected to the inspection hole by being inclined upward in the angular range of 5 degrees to 60 degrees with respect to a shaft center of the boiler water tube in a vertical state, and the ultrasonic probe is inserted from the upper side in the boiler water tube through the guide pipe. However, the base side of the guide pipe can be connected to the inspection hole by being inclined downward in the angular range of 5 degrees to 60 degrees with respect to a shaft center of the boiler water tube in a vertical state, and the ultrasonic probe can be inserted from the lower side into the boiler water tube through the guide pipe.

Further, the base side of the guide pipe is connected to the inspection hole by being inclined in the angular range of 5 degrees to 60 degrees with respect to a shaft center of the boiler water tube in a vertical state, and the ultrasonic probe is inserted into the boiler water tube through the guide pipe. However, the base side of the guide pipe can be connected to the inspection hole by being inclined in the angular range of 5 degrees to 60 degrees with respect to a shaft center of the boiler water tube in a horizontal state or in an inclined state, and the ultrasonic probe can be inserted into the boiler water tube through the guide pipe.

### INDUSTRIAL APPLICABILITY

According to the invention, a guide pipe is provided to a boiler water tube, and usually, the guide pipe is blocked by attaching a closing member to the guide pipe, thereby operating the boiler. In addition, when the thickness of the boiler water tube is measured, the closing member is released from the guide pipe, and the ultrasonic probe can be inserted into the boiler water tube through the guide pipe. Therefore, incidental work such as cutting the boiler water tube and restoring the boiler water tube after the thickness measurement, which is necessary in the related art, can be reduced, and thus a work period required for insertion-type ultrasonic wave thickness measurement of the boiler water tube can be considerably shortened. Further, since the work period required for the thickness measurement of the boiler water tube and the boiler restoration can be shortened, it is possible to easily cope with the emergency inspection of the boiler water tube.

Therefore, the invention is industrially applicable.

### REFERENCE SIGNS LIST

10,10a: BOILER WATER TUBE
11: BOILER WATER TUBES PANEL
12: UPPER END PLATE
13: LOWER END PLATE
14: HEADER
16: GUIDE PIPE
17: INSPECTION HOLE
18: ULTRASONIC PROBE
19: PROBE ACCOMMODATING UNIT
20: ALIGNING MEMBER
21: ACOUSTIC MIRROR UNIT
22: CABLE
23: FLEXIBLE METAL HOSE
24: BOLT MEMBER
25: FEMALE SCREW UNIT
26: BOLT BODY PORTION
27: BOLT HEAD PORTION
28: CLOSING PORTION
29: STEPPED PORTION
30: SEALING MEMBER
30a: WASHER

1. A method for measuring the thickness of a boiler water tube which measures the thickness of a boiler water tube by irradiating an inner circumferential surface of the boiler water tube with an ultrasonic wave from an ultrasonic probe while moving the ultrasonic probe inserted into the boiler water tube, the method comprising:
forming an inspection hole on a side surface of the boiler water tube in a longitudinal direction, connecting a base side of a guide pipe to the inspection hole, and usually, attaching a closing member to the guide pipe; and
releasing the closing member from the guide pipe, inserting the ultrasonic probe into the boiler water tube from a tip side of the guide pipe, and moving the ultrasonic probe in the boiler water tube when the thickness of the boiler water tube is measured
wherein the boiler water tube is in a vertical state, the base side of the guide pipe is connected by being inclined upward in an angular range of 5 degrees to 60 degrees with respect to a shaft center of the boiler water tube, the closing member is a long bolt member, and an air pocket is not formed in a tip side of the bolt member when the bolt member is screwed into the guide pipe.

2. (canceled)

3. A method for measuring the thickness of a boiler water tube which measures the thickness of a boiler water tube by irradiating an inner circumferential surface of the boiler water tube with an ultrasonic wave from an ultrasonic probe while moving the ultrasonic probe inserted into the boiler water tube, the method comprising:
forming an inspection hole on a side surface of the boiler water tube in a longitudinal direction, connecting a base side of a guide pipe to the inspection hole, and usually, attaching a closing member to the guide pipe; and
releasing the closing member from the guide pipe, inserting the ultrasonic probe into the boiler water tube from a tip side of the guide pipe, and moving the ultrasonic probe in the boiler water tube when the thickness of the boiler water tube is measured,
wherein the boiler water tube is in a vertical state, the base side of the guide pipe is connected by being inclined downward in an angular range of 5 degrees to 60 degrees with respect to a shaft center of the boiler water tube, and the closing member is a long bolt member.

4. A method for measuring the thickness of a boiler water tube which measures the thickness of a boiler water tube by irradiating an inner circumferential surface of the boiler water tube with an ultrasonic wave from an ultrasonic probe while moving the ultrasonic probe inserted into the boiler water tube, the method comprising:
forming an inspection hole on a side surface of the boiler water tube in a longitudinal direction, connecting a base side of a guide pipe to the inspection hole, and usually, attaching a closing member to the guide pipe; and
releasing the closing member from the guide pipe, inserting the ultrasonic probe into the boiler water tube from a tip side of the guide pipe, and moving the ultrasonic probe in the boiler water tube when the thickness of the boiler water tube is measured,
wherein the boiler water tube is in a horizontal state or an inclined state, the base side of the guide pipe is connected by being inclined in an angular range of 5 degrees to 60 degrees with respect to a shaft center of the boiler water tube, the closing member is a long bolt member, and an air pocket is not formed in a tip side of the bolt member when the bolt member is screwed into with the guide pipe.

5. The method for measuring the thickness of a boiler water tube according to claim 1, wherein a plurality of the boiler water tubes are provided, and the guide pipe is provided to all or some of the boiler water tubes as a managing target.

6. The method for measuring the thickness of a boiler water tube according to claim 1, wherein the guide pipe has a linear shape.

7. The method for measuring the thickness of a boiler water tube according to claim 1, wherein an examination of age deterioration of the boiler water tube is performed by comparing the measured thickness of the boiler water tube with reference data.

8. The method for measuring the thickness of a boiler water tube according to claim 1, wherein, when the bolt member is screwed into the guide pipe, a length of the bolt member is set so that a part of a tip of the bolt member is in contact with an edge of the bolt member on an inner circumferential surface side of the boiler water tube.

9. The method for measuring the thickness of a boiler water tube according to claim 3, wherein a plurality of the boiler water tubes are provided, and the guide pipe is provided to all or some of the boiler water tubes as a managing target.

10. The method for measuring the thickness of a boiler water tube according to claim 4, wherein a plurality of the boiler water tubes are provided, and the guide pipe is provided to all or some of the boiler water tubes as a managing target.

11. The method for measuring the thickness of a boiler water tube according to claim 3, wherein the guide pipe has a linear shape.

12. The method for measuring the thickness of a boiler water tube according to claim 5, wherein the guide pipe has a linear shape.

13. The method for measuring the thickness of a boiler water tube according to claim 9, wherein the guide pipe has a linear shape.

14. The method for measuring the thickness of a boiler water tube according to claim 10, wherein the guide pipe has a linear shape.

15. The method for measuring the thickness of a boiler water tube according to claim 3, wherein an examination of age deterioration of the boiler water tube is performed by comparing the measured thickness of the boiler water tube with reference data.

16. The method for measuring the thickness of a boiler water tube according to claim 6, wherein an examination of age deterioration of the boiler water tube is performed by comparing the measured thickness of the boiler water tube with reference data.

17. The method for measuring the thickness of a boiler water tube according to claim 11, wherein an examination of age deterioration of the boiler water tube is performed by comparing the measured thickness of the boiler water tube with reference data.

18. The method for measuring the thickness of a boiler water tube according to claim 12, wherein an examination of age deterioration of the boiler water tube is performed by comparing the measured thickness of the boiler water tube with reference data.

19. The method for measuring the thickness of a boiler water tube according to claim 13, wherein an examination of age deterioration of the boiler water tube is performed by comparing the measured thickness of the boiler water tube with reference data.

20. The method for measuring the thickness of a boiler water tube according to claim 14, wherein an examination of age deterioration of the boiler water tube is performed by comparing the measured thickness of the boiler water tube with reference data.
